(19) United States
(12) Patent Application Publication
(10) Pub. No.: US 2016/0042817 A1
(43) Pub. Date: Feb. 11, 2016

(54) Emergency Cooling System for Improved Reliability for Light Water Reactors

(71) Applicant: Arnold Otto Winfried Reinsch, Del Mar, CA (US)

(72) Inventor: Arnold Otto Winfried Reinsch, Del Mar, CA (US)

(21) Appl. No.: 14/697,469

(22) Filed: Apr. 27, 2015

Related U.S. Application Data
(60) Provisional application No. 62/020,682, filed on Jul. 3, 2014.

(51) Int. Cl. G21C 15/18; G21C 9/012; G21C 15/243

(52) U.S. Cl. CPC G21C 15/18; G21C 15/243; G21C 9/012

(57) ABSTRACT

A passive cooling system using only reactive processes without moving parts to power its startup and operation is designed to maximize the reliability of decay heat removal for the current generation of nuclear power plants and for advanced passive reactors. In order to reduce the number of failure modes processes independent from any external power source—such as the electrical power grid or Diesel generators—are used exclusively for all safety functions.

The system uses the very energy that could cause an accident to circulate cooling water through the steam generator to remove the decay heat, simplifying the design and reducing capital costs significantly. Decay heat generated by the nuclear fuel after reactor shutdown induces coolant circulation from the steam generator to the ultimate heat sink keeping the nuclear fuel at safe temperatures and preventing any release of radioactive fission products to the environment.

### CROSS-REFERENCE TO RELATED APPLICATIONS

The present application claims priority to a Provisional Application Ser. No. 62/020,682, filed Jul. 3, 2014, entitled “Emergency Cooling System with improved Reliability for the Current Generation of Light-Water Reactors” which is incorporated by reference into the instant application as if set forth verbatim.

### FIELD OF THE INVENTION

The present invention relates generally to nuclear power plant safety systems, and more particularly to systems for removing the decay heat in the event of an emergency shut down of the fission process by inserting control rods.

### BACKGROUND OF THE INVENTION

The present invention of a passive emergency cooling system using dynamic natural convection is focused on a new concept to improve the reliability of emergency cooling for the current generation of nuclear power plants. Heat removal from a nuclear plant after reactor shutdown is essential to keep the nuclear reactor core from overheating because of the decay heat that is continually generated in the reactor core after the nuclear chain reaction is stopped. However, the heat removal capability of an emergency cooling system for nuclear reactors alone is not indicative for the probability that it prevents an accident. The reliability of the system and its components is the essential characteristic that determines the probability that the system functions in an emergency. In order to attain the highest possible reliability, all the elements of the system have to be designed for high reliability. Since the failure of a single component of the safety system can lead to the complete loss of its safety function, all parts of the system have to be based on the same physical characteristics that apply to the main safety function of heat removal in an emergency cooling system.

The accident at Fukushima, Japan, showed clearly that all components of safety systems have to be highly reliable. At Fukushima all safety systems were initially fully operational. However, one element of the overall safety concept, the Diesel generators for electric power supply, failed. As a result, the entire safety system failed, the fuel overheated and melted in several reactors causing a metal-water reaction that generated hydrogen. Hydrogen-air mixtures exploded and destroyed the reactor buildings causing a large release of radioactive fission products to the environment.

In order to reduce the vulnerabilities, all elements of a safety system have to be designed with physical characteristics that lower the probability of failures significantly. The need for increased reliability of safety systems applies to all its components, not just those that maintain the principal safety function such as coolant circulation in heat removal systems. In the present invention, this requirement is addressed by using exclusively “reactive processes” to perform all safety functions of components in order to attain the highest possible reliability of core cooling. As used herein, a “reactive process” is a process that can move only in one direction while always increasing the entropy. In thermodynamic terms, it is an irreversible process.

An improved reliability of decay heat removal systems is necessary because of the severe accidents that occurred in the past 40 years like the core damage accident at Three Mile Island, the nuclear explosion at Chernobyl and the multiple accidents with hydrogen explosions at Fukushima. The Nuclear Regulatory Commission now requires the implementation of the recommendations of its Near-Term Task Force that reduce the probability of severe accidents for currently operating nuclear power plants. These severe accidents would not have occurred if passive cooling systems based on reactive technology had been installed in these nuclear power plants.

While the decay power is much lower than the full reactor power, significant energy (about 100,000 kW) is still released by a typical reactor core one minute after shutdown. It jeopardizes the integrity of the fuel elements and the reactor system boundary if continuous cooling is interrupted: The zirconium or steel cladding enclosing the uranium pellets would heat up and fail, releasing massive quantities of radioactive fission products into the reactor system. The new strategy to improve the reliability of passive heat removal systems is based on the use of reactive processes. These processes are more reliable than active systems because of the absence of moving mechanical parts during system operation and their independence from power supplies and control systems. Emergency cooling systems based on reactive processes would have prevented all major accidents that occurred in nuclear reactors including the accident at Three Mile Island, Chernobyl and Fukushima-Daiichi. A rapid response and a very large heat removal rate of the emergency cooling system are not required after reactor shutdown. However, the reliability of long-term decay heat removal for days or weeks after shutdown is essential to prevent nuclear fuel melting and the release of fission products jeopardizing the health and safety of the general public.

### SUMMARY OF THE INVENTION

At the beginning of time, perfect order existed with extremely dense matter and high concentration of energy in one place and empty space everywhere else. At that point, all processes tended to equalize the differences between pressures and enthalpies, dissipating energy and, therefore, increasing the entropy. These reactive processes were radiation, mixing, friction, natural convection, shock waves, turbulence, expansion of gases and plasma, heat conduction and any other form of energy dissipation. They are called reactive because they can only react to certain physical conditions such as high concentration of mass (high pressure) or high concentration of energy (high enthalpy). Their basic function is dissipation of energy, being pure entropy generators. In thermodynamic terms, these processes are irreversible and are marked by large increases in entropy. They are nature's way of turning order into disorder following the Second Law of Thermodynamics.

With the advent of life in the universe, a fundamentally different phenomenon appeared capable of creating order. Instead of exclusively dissipating energy and equalizing all differences, living things could differentiate, increase concentrations and pressures and even generate work, the most concentrated form of energy. Our modern society depends on powerful technologies using highly concentrated forms of energy to generate electric and mechanical power, produce materials and transport goods or process data. These technologies use energy in an efficient manner, increasing the entropy as little as possible to avoid waste. However, if malfunctions occur, safety systems have to dissipate excess energy to protect human life, property and the environment.

The inventor herein has determined that it is desirable to utilize reactive processes for as many of the safety system components as possible. It has been determined that they are the most direct and effective way to dissipate energy and are, therefore, ideally suited for reliable dissipation of large quantities of energy released during an accident. Systems utilizing reactive processes can function without continuously moving parts. All forms of potential energy can drive reactive processes, for example, the potential elastic energy stored in a spring, the potential energy stored in an elevated weight, potential energy stored in chemical compounds, energy stored in pressurized gas tanks or the kinetic energy of a flywheel. Using machinery designed for high efficiency in converting heat into work (thermodynamic cycles minimizing the increase in entropy) for safety systems designed to dissipate energy (increase the entropy) is a violation of a fundamental principle in nature (Second Thermodynamic Law).

The inventor herein has conceived that since energy dissipation is the fundamental tendency in nature, reactive processes such as heat transfer, friction and natural convection are obvious choices for safety systems: Most industrial safety systems are based on one of these reactive processes. For example, friction in brakes dissipates kinetic energy to slow down vehicles. Turbulences from safety valves dissipate energy to protect tanks and boilers from overpressure. Other examples are the spoilers on airplane wings that reduce the speed in the air and on the runway, the one-way deployment of parachutes and the dropping of anchors.

An essential characteristic of safety systems based on reactive processes is that they require only one movement of one component in one direction to create the configuration necessary for the passive safety function to develop. For example, a safety valve only has to open; then, the safety function of pressure relief by discharging fluid is passive. In a similar way, the control rods of a nuclear reactor only have to drop into the reactor core, the absorption of neutrons that follows and stops the nuclear chain reaction—the safety function proper—is a passive process and requires no continuously moving parts. These types of safety processes cannot be considered passive since one moving part is needed for start-up. However, the safety function proper of a system using a reactive process is genuinely passive as it does not require continuously moving parts.

An exception from the wide-spread application of reactive processes to industrial safety systems is the safety technology of the current generation of nuclear power plants: The emergency cooling systems of these older reactors depend still on active components with rotating pumps driven by electric motors or steam turbines requiring electric power or steam supply. In addition, active control systems are needed for reliable operation of active emergency cooling systems. The existing emergency cooling systems are, therefore, vulnerable to large disruptions from earthquakes, fires, floods or tsunamis that jeopardize the active safety functions. Emergency cooling systems for nuclear reactors using passive components have been disclosed in U.S. Pat. No. 5,398,267, U.S. Pat. No. 4,444,246 and U.S. Pat. No. 4,280,796 issued to the inventor herein. However, a consistent approach applying reactive processes to all subsystems and components of the overall safety system design is not described in these disclosures.

The present invention uses reactive processes for operation and startup obviating the need for a power supply or continuously moving parts in order to maximize the reliability of core cooling. Consequently, the system has the potential to improve the safety and reliability of nuclear power plants, especially the current generation of nuclear plants, significantly. For the highest possible reliability, it is critical that reactive processes are applied not only to the safety function itself (heat removal) but also to the startup process of the system. If reactive processes were not used in both phases (startup and operation), the overall safety function would be less reliable since the entire system is only as reliable as its least reliable subsystem.

The reactive processes utilized by the nuclear safety system of the invention include heat conduction, heat transfer, friction between fluid streams at different velocities, mixing of vapor and liquid, a standing shock wave condensing steam, and potential energy (for example, of an elastic spring or of pressurized gas) for a one-way movement opening the startup valve.

The instant emergency cooling system combines mechanical and thermodynamic effects to remove the decay heat from a nuclear reactor and reject it to a heat sink using only reactive processes. This obviates the need for a power supply (e.g. electric or hydraulic), continuously moving parts, rotating or reciprocating pumps, turbines, electric motors and control systems. The reactive system creates a thermodynamic equilibrium at low pressure and low temperature in a mixing tube located down-stream of the nozzles that discharge steam and cooling water at high pressure. The remaining sections of the cooling system (steam generator, heat exchanger and connecting pipes) remain at almost twice the pressure of the mixing tube. The exemplary system is activated by removing electrical power from a solenoid controlled valve which, in the exemplary releases stored energy in a spring to open a startup valve.

The flow ratio of steam to cooling water must be selected by the designer so that the saturation temperature and pressure of the mixture is low enough to maintain a vacuum relative to the entire cooling system. As a consequence, steam and cooling water are sucked through the nozzles into the mixing tube. Active components are not necessary to overcome the pressure rise from the mixture at low pressure flowing into the diffusor and heat exchanger at much higher pressure. The system creates two-phase flow of steam and water that passes at supersonic velocity through the low-pressure mixing tube and condenses completely in a shock wave that is capable of overcoming the pressure difference between the high system pressure and the low pressure in the mixing tube.

The conversion of momentum into pressure rise in the compression shock is essential for the emergency cooling process: The thermodynamic equilibrium created by mixing of fluids at different enthalpies sucked into the vacuum from upstream and discharged by the pressure rise of the compression shock downstream is capable of maintaining the low pressure in the mixing tube. The rest of the cooling system remains at full system pressure which is almost twice that of the pressure in the mixing tube. No mechanical devices such as rotating or reciprocating pumps, compressors or turbines are needed to separate the low-pressure volume from the rest of the cooling system. The thermodynamic process itself maintains the reduced suction pressure in the mixing tube needed for the functioning of the passive coolant recirculation process.

Supersonic flow and a shock wave develop after the mixing of sonic-flow steam with water at subsonic flow velocity in the low-pressure mixing tube. Since the supersonic velocity in the two-phase mixture is lower than the sonic flow in single-phase steam, this phenomenon is consistent with the basic physics of two-phase flow in steam-water mixtures.

The shock wave decelerating and condensing supersonic two-phase fluid into subsonic liquid together with the effect of the diffusor raise the pressure enough to return the condensate to the high-pressure regions of the system, including the steam generator and heat exchanger. Cooling water is recirculated through the heat exchanger, rejects the heat of condensation and is returned to the inlet of the water nozzle. Likewise, the steam condensed in the mixing tube by the compression shock flows back as condensate to the steam generator. The distribution of the flow returning to the steam generator and the cooling water flowing to the heat exchanger is determined by the continuity principle which reflects the fact that fluid flowing into a fixed volume is equal to the flow out of the volume if no mass is accumulated in the volume. This passive condensation and coolant recirculation process creates its own vacuum in the mixing tube by lowering the saturation pressure downstream of the nozzles and, consequently, maintaining coolant flow through the system. It is a form of natural convection based on hydrodynamic forces and thermodynamic phenomena independent from gravity and the typical elevation requirements that apply to regular (hydrostatic) natural convection. As it is generated by hydrodynamic forces, it is referred to as dynamic natural convection.

The ratio of water flow to steam flow is an important characteristic of the system. The cross sections of the steam nozzle throat and water nozzle throat that supply fluids to the mixing tube determine this ratio. Although a much larger mass flow of water than steam is required for complete condensation of the steam, the size of the cross sections are similar since the density of water is much higher than that of steam yet the exit velocity from the water nozzle is small compared to the sonic velocity of steam.

The two nozzles and the mixing tube do not represent a typical jet pump in the conventional sense of the word. Jet pumps require that the motive fluid is injected at a higher pressure than the passive fluid in order to add sufficient momentum to produce a pumping effect. In contrast, the proposed configuration maintains steam and water at a uniform pressure level prevailing upstream of the nozzles. Therefore, it can be characterized as a system of variable-diameter conduits that generates a vacuum in the mixing tube and coolant circulation by adding heat at high temperature to the steam generator and removing it at lower temperature from the heat exchanger. It produces a self-sustaining thermodynamic process creating a lower pressure in the mixing tube relative to the rest of the cooling loop remaining at a much higher pressure level.

The physical processes that occur in the system such as mixing, turbulences, heat transfer and compression shock cause significant thermodynamic losses increasing the entropy. As a consequence and because of the high-reliability design of the system, the overall efficiency of the process in terms of pumping power versus heat input is low. However, simplicity and low efficiency improve the reliability of the process which is much higher than that of conventional cooling systems using rotating pumps, turbines and electric motors that depend on multiple moving parts, power supply and control systems. If active systems designed for high efficiency would be used in the system, its reliability would inevitably be much lower. Since safety systems must have the highest possible reliability to provide the safety function with certainty in the event of an accident, passive components with low system efficiency, reactive processes, are ideally suited for safety systems. In addition, simplicity and independence from support systems offer the essential benefits of a reduced human error potential and low cost.

An important design feature of the proposed emergency cooling system is that the same principles are applied to the startup process as to the safety function (heat removal) itself in order to maximize safety and reliability: Only reactive processes which increase the entropy without continuously moving parts are used. Electric power, Diesel generators, thermodynamic cycles or external power supply (all designed for high efficiency) cannot be used for startup and operation in order to gain the highest possible reliability of the safety function.

### BRIEF DESCRIPTION OF THE DRAWINGS

These and other features of the invention are described in further detail in the following description and will be better understood with reference to the accompanying drawings, which are briefly described below.

FIG. 1 shows a simplified scheme of the emergency cooling system based exclusively on reactive processes;

FIG. 2 represents a start-up valve for the emergency cooling system with its actuator using a reactive process to attain maximum reliability for valve opening;

FIG. 3 illustrates the design of a valve with its seat at the inner wall of the steam nozzle throat in order to enhance the flow during system start-up while the valve is in the process of opening.

FIG. 4 shows an arrangement for cooling the inlet of the water nozzle and the cooling water supply pipe in order to prevent heating of the cooling water in the event of leakage past the closed start-up valve during regular power operation of the nuclear power plant (i.e. before startup of the emergency cooling system).

FIG. 5 shows an application of reactive processes for pressure relief in the pressurizer of a pressurized water reactor.

### DETAILED DESCRIPTION

Exemplary embodiments of the invention are described in detail below with reference to the appended figures, wherein like elements are referenced with like numerals throughout. The figures are not necessarily drawn to scale and do not necessarily show every detail or structure of the various embodiments of the invention, but rather illustrate exemplary embodiments and mechanical features in order to provide an enabling description of such embodiments.

The purpose of the system is to remove decay heat from a nuclear power plant to prevent an accident in the event of equipment failures such as complete loss of electric power (“station black-out”), a fire or a small pipe break (a loss-of-coolant accident, “LOCA”). Steam may be removed from the reactor vessel of a boiling-water reactor (BWR) or the steam generator in the secondary loop of a pressurized-water reactor (PWR) or the steam generator in the tertiary loop of a liquid-metal-cooled fast breeder reactor (LMFBR). The emergency cooling system removes the steam, condenses it, rejects the heat of condensation to the ultimate heat sink and returns the condensate to the steam generator without using external power or a control system. The ultimate heat sink for example can be any large body of water such as a cooling pond, river, ocean water, and the water in the torus of a BWR or the condensate tank of a typical nuclear power plant. Any heat sink suitable for long-term absorption of the nuclear decay heat can be used so long as the heat sink can absorb the decay heat of the reactor for the time required by the regulatory agency, for example 72 hours. The heat transfer mechanism on the secondary side of the heat exchanger is hydrostatic natural convection induced by the large temperature difference between the hot water discharged from the mixing tube and the cold water stored in the heat sink.

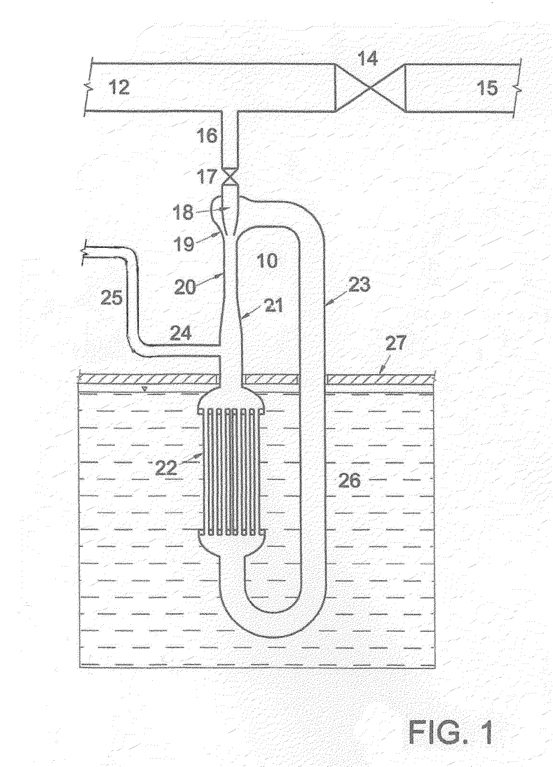

FIG. 1 shows the main steam pipe 12 delivering steam from the steam generator through the main steam isolation valve 14 and pipe 15 to the conventional part of a nuclear plant producing electricity during normal power operation. In the event of a malfunction, the reactor will be automatically shut down and the main steam isolation valve 14 will be closed. Even after the nuclear chain reaction has stopped, the core still generates decay heat that has to be removed from the reactor to prevent fuel damage and a release of radioactive fission products to the environment.

This is accomplished by the present emergency cooling system 10 in a passive way with improved reliability. Opening valve 17 diverts steam from the main steam pipe 12 through pipe 16 and convergent nozzle 18 into the mixing tube 20. As used herein convergent nozzle should be understood to mean a nozzle that converges more than it diverges. The steam condenses by mixing with water at lower temperature from the convergent water nozzle 19 supplied by heat exchanger 22 through pipe 23. Even after absorbing the heat of condensation, the mixture temperature is low enough to result in a much lower saturation pressure than the system pressure imparted by the steam generator that serves as pressurizer for the emergency cooling system. Although 18 is shown as being within the nozzle 19, the positions of the nozzles can be reversed.

A significantly lower mixing tube pressure than that of the rest of the emergency cooling system is essential for the passive heat removal process to start and to function. A low saturation pressure and temperature is attained by selecting a suitable flow ratio between steam and water in the nozzles. This is accomplished by designing the system with proper area ratios between the three characteristic areas of the system:

1. The ratio of the flow area cross section of the water nozzle throat to that of the steam nozzle throat should be larger than 1.1:1

2. The ratio of the smallest flow area of the mixing tube to the flow area of the water nozzle should be larger than 1.3:1

3. The ratio of the surface area of the heat exchanger to the flow area cross section of the steam nozzle throat should be larger than 12,000:1

For the emergency cooling system using dynamic natural convection to operate with maximum effect, the ratios between these three areas should be larger than the above limits.

The large momentum imparted to the water by the steam exiting the nozzle 18 at sonic velocity is converted into a pressure rise by a compression shock condensing the steam of the two-phase mixture consisting of steam and water. In addition, the diffusor 21 raises the fluid pressure further enhancing the recirculation of coolant through heat exchanger 22 and pipe 23 as well as the return of the condensate to the steam generator through pipes 24 and 25. Pipe 25 includes a vertical section designed to reduce heat transfer between the saturated water of the steam generator and the components 20, 21 and 23 of the emergency cooling system during normal plant operation. Heating of components 20, 21 and 23 would reduce the driving potential of the emergency cooling system during startup.

The high reliability of the present emergency cooling system is based on the utilization of reactive processes that depend on hydrodynamic forces, heat transfer, elastic potential energy and friction to induce coolant circulation. However, under stagnant conditions before startup, hydrodynamic forces do not exist. Therefore, a hydrostatic phenomenon is used to create a vacuum in the mixing tube and start the coolant flow in the emergency cooling system. In the shut-down state, the entire cooling loop with nozzles 18 and 19, mixing tube 20, diffusor 21, piping 23, 24, 25 and heat exchanger 22 is filled with water. By locating startup valve 17 (FIGS. 1, 2 and 3) about 0.3 to 8 meters above the water level in the steam generator, a negative pressure difference (suction) of about 0.03 to 0.8 bar is created across startup valve 17. After opening valve 17, the water in pipe 16 and nozzle 18 will be sucked through the steam nozzle throat into volume 20. This provides enough momentum to initiate steam flow at velocities of about 20 meter/sec through the steam nozzle 18 and induce water flow through the water nozzle 19. As soon as steam and cold water come into contact, the more powerful thermodynamic phenomena of combined heat and momentum transfer result in rapid condensation of steam creating a stronger vacuum in the mixing tube and sonic steam flow at 440 meter/sec in the throat of steam nozzle 18. The water flow accelerates in water nozzle 19 resulting in supersonic two-phase flow inside the mixing tube 20 that ends suddenly in a condensation shock wave. An elevation difference of 0.3 to 8 meters can easily be fitted into existing containment buildings of the current generation of nuclear power plants without significant design constraints to the present emergency cooling system.

Most of the emergency system components can be located inside the containment protected by the thick walls of the containment building against tornados, missiles, terrorist attacks or other external threats. The exception is heat exchanger 22 which may be located outside the containment building in an exterior ultimate heat sink 26 exposed to hazards from external events. Since the heat exchanger rejects the decay heat to the ultimate heat sink, it is of importance for the heat removal function of the emergency cooling system and has to have the same level of protection as all other emergency system components. Missile shield 27 (FIG. 1) is included in the design for this purpose, protecting heat exchanger 22 and the heat sink 26 against missiles, explosions and other external events.

Startup valve 17 is the only component of the system that has a moving part required for startup of the emergency cooling system 10. Except for valve 17, therefore, the entire emergency cooling system has a fixed geometry. Moving valve disk 31 out of the flow path produces the geometry necessary for dynamic natural convection to develop in the emergency cooling loop and remove the decay heat from the reactor. All other functions of the cooling system including the rejection of heat to the ultimate heat sink are passive and require no moving parts or power supply for startup and operation. Opening valve 17 by moving the valve disk 31 out of the flow path is essential for the safety function of emergency cooling system 10. Therefore, start-up valve 17 and its actuator 32 have to be designed to function with the highest possible reliability.

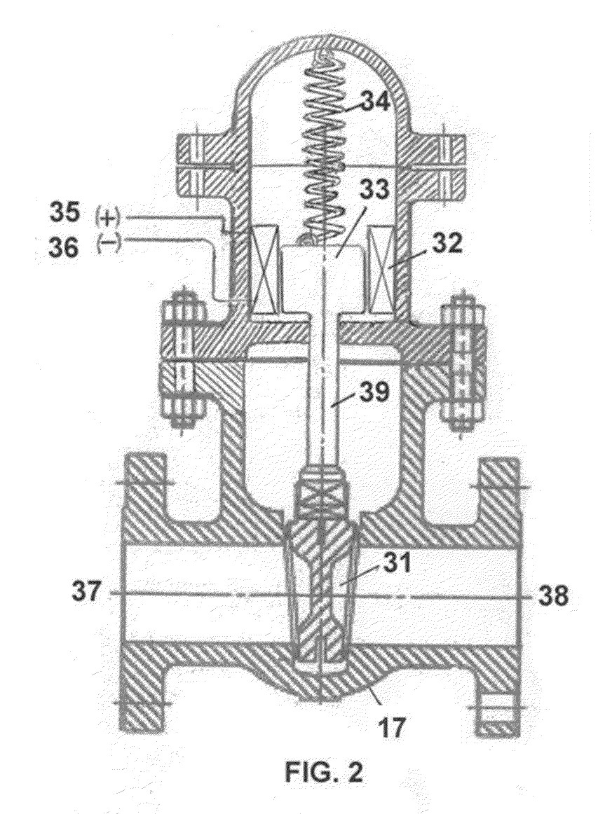

High reliability is accomplished by selecting a reactive process as driver for the valve actuator shown in FIG. 2. In this example, the potential elastic energy of a spring 34 is used to move the valve disk 31 out of the flow path of valve 17, opening the flow path. The use of the stored potential energy of spring 34 for start-up is one example. Other forms of stored potential energy such as pressurized gas in a tank can be used. During normal operation of the nuclear plant in the instant embodiment, a solenoid coil 32 is energized with the movable core 33 in the position shown, keeping the valve closed. As long as the electric current flows through coil 32 from electrical connection 35 to connection 36, the coil forces the movable iron core 33 downward keeping valve disk 31 in the flow path and valve 17 closed. Loss of electric power or a control system signal cutting electric power would cause solenoid coil 32 to be de-energized and release core 33 so that the spring 34 instantly withdraws disk 31 opening valve 17.

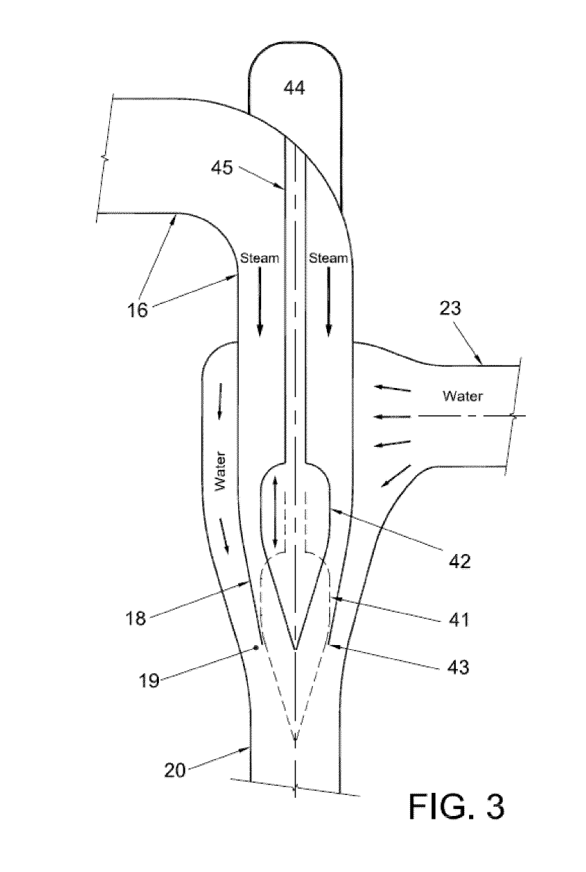

FIG. 3 shows another improvement of the startup process of the passive emergency cooling system: Streamlined valve part 41 is seated against the inside of the throat 43 of the steam nozzle 18 closing the flow path completely. Upon partial withdrawal of the streamlined valve part 41 to location 42 during opening of the valve, the flow resistance in the valve is reduced, increasing the velocity of the water initially discharged by nozzle 18 and improving the startup characteristic significantly: If only a small fraction of the flow path is open, the throat of a convergent nozzle is formed by the streamlined valve part 41 and the inside 43 of the steam nozzle throat. As a consequence, a high-velocity water jet is injected initially into the mixing tube and sonic flow can develop faster in the converging steam nozzle 18 although the valve is only partially open during the transition from closed to open. In this configuration, more enthalpy of the steam and water is converted into kinetic energy avoiding unnecessary throttling of the expanding fluids, resulting in a faster and smoother startup of the emergency cooling system.

This is different from a typical gate (FIG. 2) or globe valve where most of the kinetic energy during the early phase of startup (when the flow path in valve 17 is still small compared to the throat of the steam nozzle) is lost in turbulence and does not contribute to developing coolant flow in the system. Part 41 in FIG. 3 moves parallel to the flow direction in contrast to valve disk 31 in FIG. 2 which moves perpendicular to the flow direction. For maximum reliability, the actuator 44 for the valve shown in FIG. 3 has to use a similar reactive process as that of valve 17. However, its movement which is transmitted by rod 45 to part 41 is parallel to the flow direction.

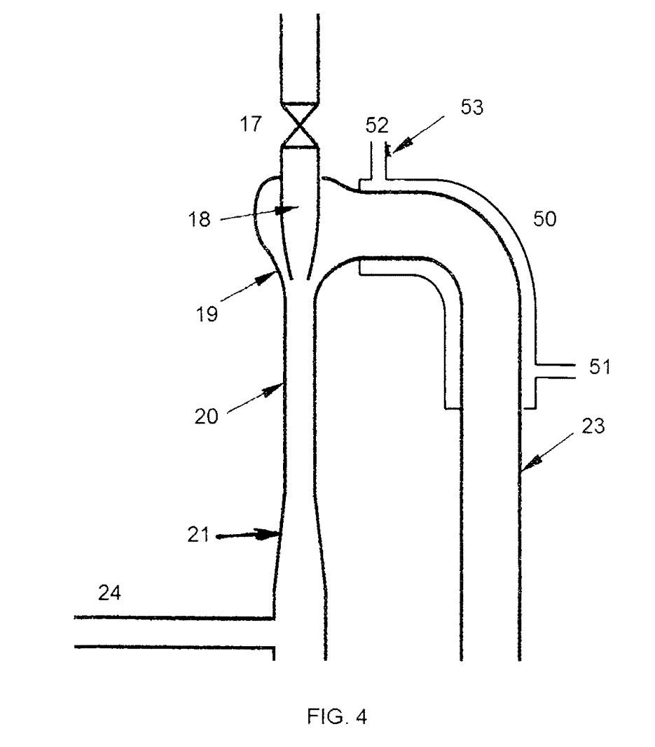

An additional improvement (FIG. 4) of the reliability of the present emergency cooling system can be gained by removing heat from the piping in the vicinity of the start-up valve during normal operation of the nuclear power plant (when valve 17 is closed and the emergency cooling system is shut down). A potential failure mode during start-up of the emergency cooling system could be caused by leakage of steam from pipe 16 through valve 17 into nozzle 18 and pipe 23 before startup. It would heat up the water in pipe 23 upstream of nozzle 19 so that the heated cooling water could not completely absorb the heat of condensation of the steam in the mixing tube 20 during startup. This could jeopardize the startup of the system, resulting in the failure of its emergency safety function.

During regular operation of the nuclear power plant, a small cooling water flow from the component cooling water system to cooling jacket 50 through pipe 51 and returning through pipe 52 can prevent the build-up of heat in pipe 23 of the safety system and maintain its readiness. This additional safety measure is only needed in the shut-down state of the emergency cooling system (during regular operation of the nuclear power plant). After start-up of the emergency cooling system, external cooling is not required since the system is supplying large quantities of cooling water to remove heat from the reactor after an accident. Although the cooling function preventing heat-up of the shut-down emergency cooling system requires active components for coolant circulation through the jacket 50 before the start-up of the emergency system, the passive emergency system itself does not need any active components for its safety function during emergency operation. A temperature sensor 53 attached to cooling jacket 50 would transmit an alarm signal to the control room if the cooling water temperature exceeds a limit during normal operation of the nuclear power plant, informing the operators of the problem in order to initiate a repair of the valve before an emergency occurs. A similar effect caused by thermal pollution from the steam generator through pipe 24 and 25 would also be prevented by the cooling jacket.

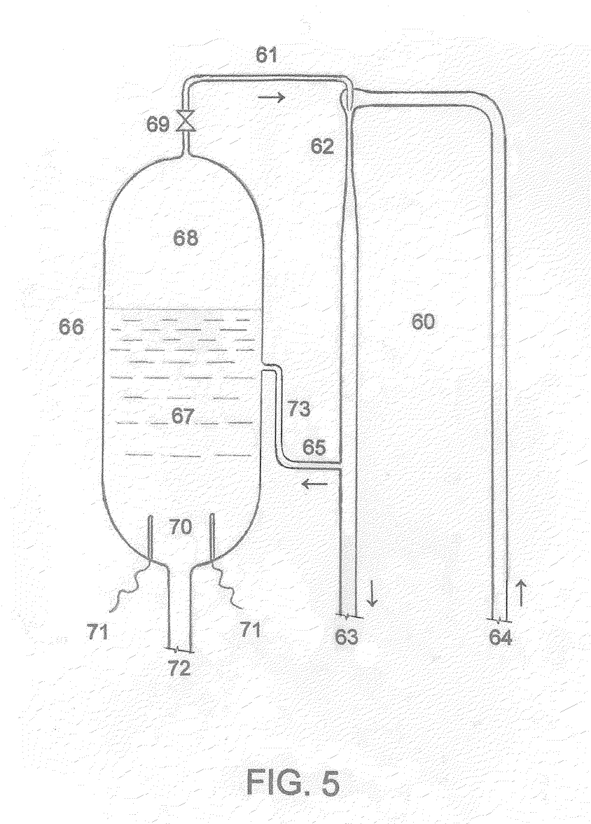

An important variation of the present emergency cooling system improving the safety and reliability of nuclear power plants is the use as pressure relief system for the pressurizer 66 (FIG. 5) of a pressurized water reactor (PWR). Currently, this function is performed by power-operated relief valves 69 or safety valves connected to the pressurizer steam space 68. These valves are capable of reliably removing excess energy from the pressurizer and protecting it from overpressure during transients. However, the valves discharge reactor coolant for pressure relief. In contrast, the present emergency cooling system 60 does not cause any coolant loss in the process of heat removal and reducing the pressure in the pressurizer 66 and the reactor coolant system. Condensing the steam and returning the condensate is more effective than steam removal alone because of the low temperature of the condensate (about 200° C.) returned to the pressurizer which is at a temperature of about 350° C.

A pressurizer operates similar to a small steam generator at high temperature and pressure. Electric heaters keep the temperature in the pressurizer constant by adding heat if temperature and pressure drop below the lower limits. However, the energy added by the electrical heater elements 70 through cables 71 generates only small amounts of steam sufficient to compensate for transient temperature changes or condensation on the pressurizer walls caused by heat losses.

The pressurizer is filled with saturated water 67 which is in thermal equilibrium with steam 68 at a pressure of about 160 bar and a temperature of 350 Degree C. The saturated water 67 of the pressurizer connected to the hot leg of the reactor primary system through pipe 72 imparts the saturation pressure of the water to the entire reactor coolant system. Valve 69 connected to the steam space 68 is closed during normal plant operation to maintain the pressure in the reactor coolant system. If an emergency cooling system is connected to valve 69, opening the valve causes steam from the pressurizer to flow through pipe 61 into the mixing volume 62 and condense by direct contact with water at low temperature from line 64. The actuation of valve 69 at the pressurizer would start the process of emergency cooling and steam relief.

Pressurizer steam relief by the emergency cooling system offers several advantages over the current designs using relief valves and especially over the new advanced passive reactors: The emergency cooling system works like a pressurizer relief valve reducing pressure spikes in the reactor coolant system. However, it would not cause any loss of coolant as relief valves do. This is important in the case of an inadvertent valve actuation. The effect of overpressure protection without potential loss of coolant reduces the nuclear risk from the current nuclear reactor generation and enhances especially the safety of advanced passive reactors.

In the designs of advanced passive reactors, opening of a single pressurizer relief valve requires the subsequent actuation of several banks of relief valves with increasing capacity leading to a complete coolant blowdown and depressurization of the reactor coolant system. This is necessary if gravity is used for passive refilling of the reactor system with coolant. Since the emergency cooling system does not discharge reactor coolant from the system, pressure spikes can be controlled by it without the sequential actuation of all relief valve banks leading to a complete coolant blowdown (similar to a large loss-of-coolant accident, LOCA).

Various modifications and alterations of the invention will become apparent to those skilled in the art without departing from the spirit and scope of the invention, which is defined by the accompanying claims. For example, it should be noted that steps recited in any method claims below do not necessarily need to be performed in the order they are recited. For example, in certain embodiments, steps may be performed simultaneously. The accompanying claims should be construed with these principles in mind.

What is claimed is:

1. A safety system for nuclear reactors to dissipate decay heat after the nuclear reaction is terminated, comprising:
nozzles for circulating a two-phase flow generated by steam produced by the decay heat in a reactor vessel which is injected through a first nozzle configured to create condensation of the steam in the two phase flow by compression shock, the pressure of the fluid in the first nozzle throat being substantially below the pressure of the fluid in the remainder of the system, a cooling loop for directing liquid from the compression shock into a heat exchanger to remove the heat of condensation from the fluid and return the resulting flow to a second nozzle, a startup valve which is operated by releasing stored potential energy to commence flow through the nozzle.

2. The system according to claim 1, wherein: the water from the cooling loop is mixed with the fluid exiting the first nozzle through a second nozzle surrounding the first nozzle or surrounded by the first nozzle.

3. The system according to claim 1, wherein: the operation of the startup valve is initiated by the absence of electrical power which releases stored energy to the startup valve.

4. The system of claim 3, wherein: the startup valve is normally held closed by an electrically powered solenoid.

5. The system according to claim 4, wherein: the stored energy is in the form of a compressed or extended elastic spring.

6. The system according to claim 4 where the stored energy is in the form of compressed gas.

7. A system for removing decay heat from a shut-down nuclear reactor comprising the steps of: opening a startup valve to admit steam flow from a reactor vessel, a first nozzle downstream of the startup valve for introducing the steam flow from the reactor vessel to an emergency cooling system, the first nozzle being convergent over substantially the entire length, a heat exchanger for removing the heat of condensation from the flow and mixing the subcooled water flow from the heat exchanger with the steam flow from the reactor vessel through a second nozzle surrounding or surrounded by the first nozzle,
The combined flows from the first and second nozzles produce a condensation shock to liquefy steam at a pressure exceeding the pressure in the remainder of the safety system and reactor vessel to induce continuous coolant flow.

8. A system for removing decay heat from a shut-down nuclear reactor comprising the steps of: opening a startup valve to admit steam flow from a steam generator, a first nozzle downstream of the startup valve for introducing the steam flow from the steam generator to an emergency cooling system, a heat exchanger for removing the heat of condensation from the flow and mixing the subcooled water flow from the heat exchanger with the steam flow from the steam generator through a second nozzle surrounding or surrounded by the first nozzle, the combined flows from the first and second nozzles produce a condensation shock to liquefy steam at a pressure exceeding the pressure in the remainder of the safety system and steam generator to induce continuous coolant flow.

9. A method for removing decay heat from a shut-down nuclear reactor and for pressure relief comprising the steps of: opening a startup valve to admit steam flow from a pressurizer to a first nozzle downstream of the startup valve for introducing the steam flow from the pressurizer to an emergency cooling system, introducing the flow from the first nozzle to a heat exchanger or tank for removing the heat of condensation from the flow and mixing the subcooled water flow from the heat exchanger or tank with the steam flow from the pressurizer through a second nozzle surrounding or surrounded by the first nozzle, the combined flows from the first and second nozzles produce a condensation shock to liquefy steam at a pressure exceeding the pressure in the remainder of the safety system and pressurizer to induce continuous coolant flow.

10. The system according to claim 1, wherein: a mixing tube is located downstream of the nozzles,
The ratio of the cross section of the water flow area of the second nozzle throat to the cross section of the steam flow area of the first nozzle throat is at least 1.1 in order to condense the steam in the mixing tube completely.

11. The system according to claim 1, wherein: a mixing tube is located downstream of the nozzles,
The ratio of the cross section of the flow area of the mixing tube to the cross section of the water flow area of the second nozzle throat is at least 1.3 in order to insure an effective compression shock.

12. The system according to claim 7, wherein: The ratio of the heat exchanger surface area to the cross section of the steam flow area of the first nozzle throat is at least 12,000 to reject the decay heat at a sufficiently low temperature level.

13. The system of claim 9, wherein: After startup, a streamlined valve part is moved relative to the first nozzle to increase the steam flow velocity and flow volume.

14. The system of claim 9, wherein:
for startup, the streamlined valve part is moved relative to the first nozzle to increase the flow velocity and flow volume which is operated by releasing stored potential energy to increase flow through the nozzle.
